(19) United States
(12) Patent Application Publication
(10) Pub. No.: US 2026/0154867 A1
(43) Pub. Date: Jun. 4, 2026

(54) SYSTEM AND METHOD FOR GENERATING GARMENT PATTERN SIMULATION DRAWING

(71) Applicant: FU JEN CATHOLIC UNIVERSITY, New Taipei City (TW)

(72) Inventors: Ying-Chia HUANG, New Taipei City (TW); Jie-Yuan ZHENG, New Taipei City (TW)

(21) Appl. No.: 19/197,280

(22) Filed: May 2, 2025

(30) Foreign Application Priority Data
Dec. 4, 2024 (TW) 113147026

(51) Int. Cl. G06T 11/20

(52) U.S. Cl. CPC G06T 11/23; G06T 2210/16

(57) ABSTRACT

Provided are a system and a method for generating a garment pattern simulation drawing. The system includes an input device configured for inputting a standardized design drawing and a design drawing contour; a contour type identification module configured for identifying a type of the design drawing contour; a definition module configured for defining the number of human body blocks and joints corresponding to the design drawing contour; a pattern generation module configured for calculating a combination number of garment technical drawings; a garment technical and simulation drawing module configured for generating a garment technical drawing and plotting a garment simulation drawing on the design drawing contour according to the garment technical drawing; and a garment pattern simulation drawing module configured for generating a one-piece garment pattern simulation drawing according to the garment simulation drawing.

### BACKGROUND

### 1. Technical Field

The present disclosure relates to a system for generating a garment pattern simulation drawing and a method thereof, and more particularly, to a system of and a method of automatically generating a garment pattern simulation drawing by using a computer.

### 2. Description of Related Art

Many innovative handcrafted methods are often used in the design and production of existing garments. Since these innovative handcrafted methods cannot be easily standardized by machines, they can only rely on manual labor, thereby resulting in time-consuming, labor-intensive, and costly shortcomings.

Also, in the existing garment sampling process, garment designers can only rely on manual labor after creating a difficult design, such that garment designers still need to spend a longer time on sampling, thereby increasing development costs. The trial-and-error method of constructing the initial garment samples leads to high fabric consumption, high garment costs and high production prices.

### SUMMARY

The present disclosure provides a system for generating a garment pattern simulation drawing. The system comprises: an input device configured for inputting a standardized design drawing and a design drawing contour, wherein the standardized design drawing includes a mesh and a mannequin in the mesh, and the design drawing contour is attached to a part of the mannequin; a contour type identification module configured for identifying a type of the design drawing contour by defining a position of the mannequin to which the design drawing contour is attached according to the mesh; a definition module configured for defining number of human body blocks and joints corresponding to the design drawing contour according to the type of the design drawing contour; a pattern generation module configured for calculating a combination number of garment technical drawings by means of using a corresponding algorithm according to the number of the human body blocks, the joints and cutting lines; a garment technical and simulation drawing module configured for generating a garment technical drawing according to the combination number of the garment technical drawings and plotting a garment simulation drawing on the design drawing contour according to the garment technical drawing; and a garment pattern simulation drawing module configured for generating a one-piece garment pattern simulation drawing according to the garment simulation drawing.

The present disclosure further provides a method for generating a garment pattern simulation drawing. The method comprises: inputting a standardized design drawing and a design drawing contour into an input device, wherein the standardized design drawing includes a mesh and a mannequin in the mesh, and the design drawing contour is attached to a part of the mannequin; identifying a type of the design drawing contour by a contour type identification module by means of defining a position of the mannequin to which the design drawing contour is attached according to the mesh; defining number of human body blocks and joints corresponding to the design drawing contour by a definition module according to the type of the design drawing contour; calculating a combination number of garment technical drawings by a pattern generation module by means of using a corresponding algorithm according to the number of the human body blocks, the joints and cutting lines; generating a garment technical drawing according to the combination number of the garment technical drawings and plotting a garment simulation drawing on the design drawing contour according to the garment technical drawing by a garment technical and simulation drawing module; and generating a one-piece garment pattern simulation drawing by a garment pattern simulation drawing module according to the garment simulation drawing.

In the aforementioned system and method for generating the garment pattern simulation drawing, the type of the design drawing contour includes a sleeve, a high-waisted and ankle-length skirt and a T-shirt.

In the aforementioned system and method for generating the garment pattern simulation drawing, the sleeve corresponds to two human body blocks and one joint, the high-waisted and ankle-length skirt corresponds to four human body blocks and three joints, and the T-shirt corresponds to six human body blocks and five joints.

In the aforementioned system and method for generating the garment pattern simulation drawing, the algorithm is as follows: if the number of the human body blocks is 3, the number of the joints is 2, and the number of the cutting lines of parallel joints is k, the combination number of the

$$garment technical drawings = \frac{( k + 2 ) \cdot ( k + 1 )}{2} ;$$

if the number of the human body blocks is n, the number of the joints is n−1, and the number of the cutting lines of the parallel joints is 2, the combination number of the

$$garment technical drawings = \frac{( n + 1 ) \cdot n}{2} ;$$

and if the number of the human body blocks is n, the number of the joints is n−1, and the number of the cutting lines of the parallel joints is k, the combination number of the

$$garment technical drawings = \frac{( n + k - 1 ) !}{( n - 1 ) ! \cdot k !} .$$

In the aforementioned system and method for generating the garment pattern simulation drawing, the algorithm is as follows: if the number of the human body blocks is 3, the number of the joints is 2, and the number of the cutting lines of vertical joints is k, the combination number of the garment technical drawing is 6^{k}; if the number of the human body blocks is n, the number of the joints is n−1, and the number of the cutting lines of the vertical joints is 2, the combination number of the

$$garment technical drawings = {( \frac{n \cdot ( n + 1 )}{2} )}^{2} ;$$

and if the number of the human body blocks is n, the number of the joints is n−1, and the number of the cutting lines of the vertical joints is k, the combination number of the

$$garment technical drawings = {( \frac{n \cdot ( n + 1 )}{2} )}^{k} .$$

In the aforementioned system and method for generating the garment pattern simulation drawing, the algorithm is as follows: if the number of the human body blocks is n, the number of the cutting lines of parallel joints is k1, and the number of the cutting lines of vertical joints is k2, the combination number of the

$$garment technical drawings = \frac{( n + k 1 - 1 ) !}{( n - 1 ) ! k 1 !} \times {( \frac{n ( n + 1 )}{2} )}^{k 2} ;$$

and if the number of the joints in a longitudinal direction is n1, the number of the joints in a transverse direction is n2, the number of the cutting lines in the longitudinal direction is k1, and the number of the cutting lines in the transverse direction is k2, the

$$garment technical drawings = {\sum }_{i = 0}^{k 1} \frac{( n 2 + i - 2 ) !}{( n 2 - 2 ) ! \times i !} \times {( \frac{n 1 ( n 1 + 1 )}{2} )}^{k 1 - i} \times {\sum }_{i = 0}^{k 2} \frac{( n 1 + i - 2 ) !}{( n 1 - 2 ) ! \times i !} \times {( \frac{n 2 ( n 2 + 1 )}{2} )}^{k 2 - i} ,$$

wherein n1≠1, n2≠1 and k1+k2≠0.

In the aforementioned system and method for generating the garment pattern simulation drawing, the input device is a tablet, a laptop, a desktop, a cell phone, or a scanner.

In summary, the system and method for generating a garment pattern simulation drawing of the present disclosure can identify the types of design drawing contours, calculate a combination number of garment technical drawings according to the number of human body blocks, joints and cutting lines, generate various permutations and combinations of garment technical drawings and corresponding garment simulation drawings, and ultimately generate various permutations and combinations of one-piece garment pattern simulation drawings. The system and method for generating a garment pattern simulation drawing of the present disclosure can provide inspiration for various permutations and combinations of the garment patterns, cutting lines, number of cutting lines and direction of cutting lines, thereby helping garment designers to enhance the efficiency of garment pattern research and development. In addition, the system and method for generating a garment pattern simulation drawing of the present disclosure can instantly calculate and automatically generate garment technical drawings, garment simulation drawings and garment pattern simulation drawings, thereby effectively improving the sampling time for realizing designs.

### BRIEF DESCRIPTION OF THE DRAWINGS

FIG. 1 is a schematic diagram showing a structure of a system for generating a garment pattern simulation drawing according to an embodiment of the present disclosure.

FIG. 2 is a schematic diagram showing a structure of a system for generating a garment pattern simulation drawing according to another embodiment of the present disclosure.

FIG. 3 is a flowchart showing a method for generating a garment pattern simulation drawing according to the present disclosure.

FIG. 4A is a schematic front view of a standardized design drawing and a design drawing contour of a sleeve according to the present disclosure.

FIG. 4B is a schematic side view of a standardized design drawing and a design drawing contour of a sleeve according to the present disclosure.

FIG. 5A is a schematic front view of a standardized design drawing and a design drawing contour of a high-waisted and ankle-length skirt according to the present disclosure.

FIG. 5B is a schematic side view of a standardized design drawing and a design drawing contour of a high-waisted and ankle-length skirt according to the present disclosure.

FIG. 6A is a schematic front view of a standardized design drawing and a design drawing contour of a T-shirt according to the present disclosure.

FIG. 6B is a schematic side view of a standardized design drawing and a design drawing contour of a T-shirt according to the present disclosure.

FIG. 7A is a garment technical drawing of a sleeve according to the present disclosure.

FIG. 7B and FIG. 7C are garment technical drawings of a high-waisted and ankle-length skirt according to the present disclosure.

FIG. 7D and FIG. 7E are garment technical drawings of a T-shirt according to the present disclosure.

FIG. 8A is a garment simulation drawing of a sleeve according to the present disclosure.

FIG. 8B is a garment simulation drawing of a high-waisted and ankle-length skirt according to the present disclosure.

FIG. 8C is a garment simulation drawing of a T-shirt according to the present disclosure.

FIG. 9A is a garment pattern simulation drawing of a sleeve according to the present disclosure.

FIG. 9B is a garment pattern simulation drawing of a high-waisted and ankle-length skirt according to the present disclosure.

FIG. 9C is a garment pattern simulation drawing of a T-shirt according to the present disclosure.

### DETAILED DESCRIPTION

The following describes the implementation of the present disclosure with examples. Those skilled in the art can easily understand other advantages and effects of the present disclosure from the content disclosed in this specification.

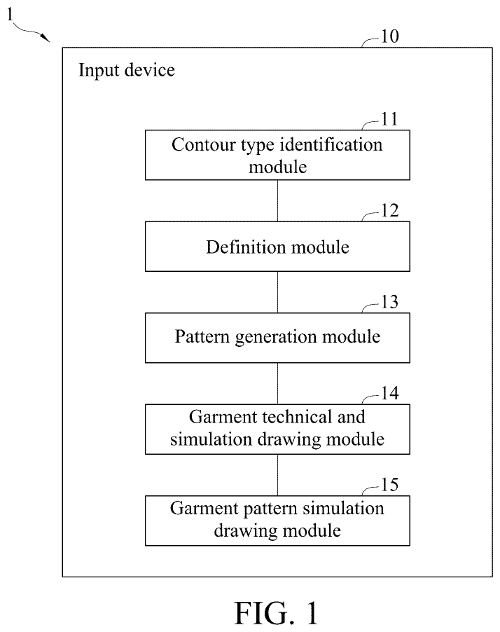

FIG. 1 is a schematic diagram showing a structure of a system 1 for generating a garment pattern simulation drawing according to an embodiment of the present disclosure. The system 1 for generating the garment pattern simulation drawing includes an input device 10, a contour type identification module 11, a definition module 12, a pattern generation module 13, a garment technical and simulation drawing module 14 and a garment pattern simulation drawing module 15.

In an embodiment, the input device 10 is a tablet computer, a laptop, a cell phone, or a desktop computer that has a microprocessor, and the contour type identification module 11, the definition module 12, the pattern generation module 13, the garment technical and simulation drawing module 14 and the garment pattern simulation drawing module 15 are code snippets, software, or firmware run by hardware such as a tablet computer, a laptop, a cell phone, or a desktop computer.

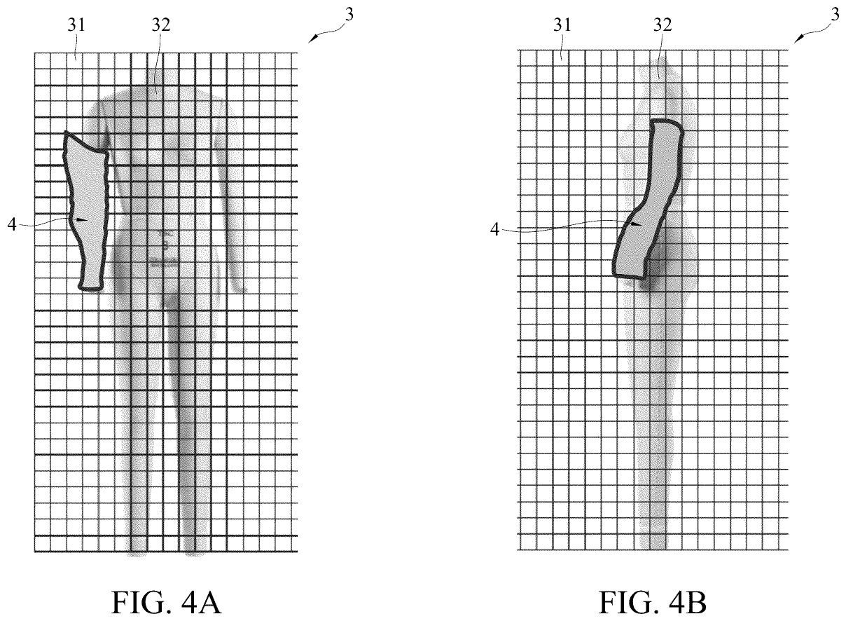

Referring to FIG. 4A and FIG. 4B, the input device 10 is used to input a standardized design drawing 3 and a design drawing contour 4. The standardized design drawing 3 includes a mesh 31 and a mannequin 32 in the mesh 31. In an embodiment, each grid in the mesh 31 is a square, and the square corresponds to a dimension of 5 centimeters in width and 5 centimeters in height of the mannequin 32. The specific position of the mannequin 32 in the standardized design drawing 3 can be indicated by the mesh 31. For example, a coordinate system may be used for labeling. The specific positions of the upper arms, lower arms, front chest, back, abdomen, waist, hips, stomach, buttocks, thighs, calves, knee joints, left shoulder joint, right shoulder joint and other parts in the mannequin 32 can be specifically labeled. The design drawing contour 4 is attached to a part of the mannequin 32. In an embodiment, the design drawing contour 4 is attached to the standardized design drawing 3 displayed on the screen of the input device 10 by means of computer graphics (e.g., by means of graphics software, etc.).

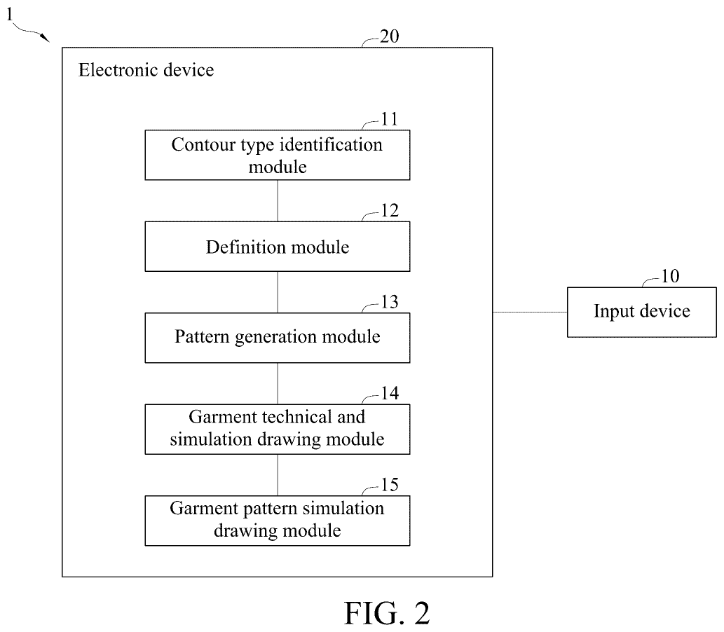

In an embodiment, as shown in FIG. 2, the input device 10 is a scanner, and the contour type identification module 11, the definition module 12, the pattern generation module 13, the garment technical and simulation drawing module 14 and the garment pattern simulation drawing module 15 are code snippets, software, or firmware run by an electronic device 20. For example, the electronic device 20 may be a hardware such as a tablet computer, a laptop, a cell phone, or a desktop computer that has a microprocessor. The design drawing contour 4 may be hand-drawn on a standardized design drawing 3 in paper form, scanned into an electronic file by a scanner, and then loaded into the electronic device 20 for use by the contour type identification module 11, the definition module 12, the pattern generation module 13, the garment technical and simulation drawing module 14 and the garment pattern simulation drawing module 15.

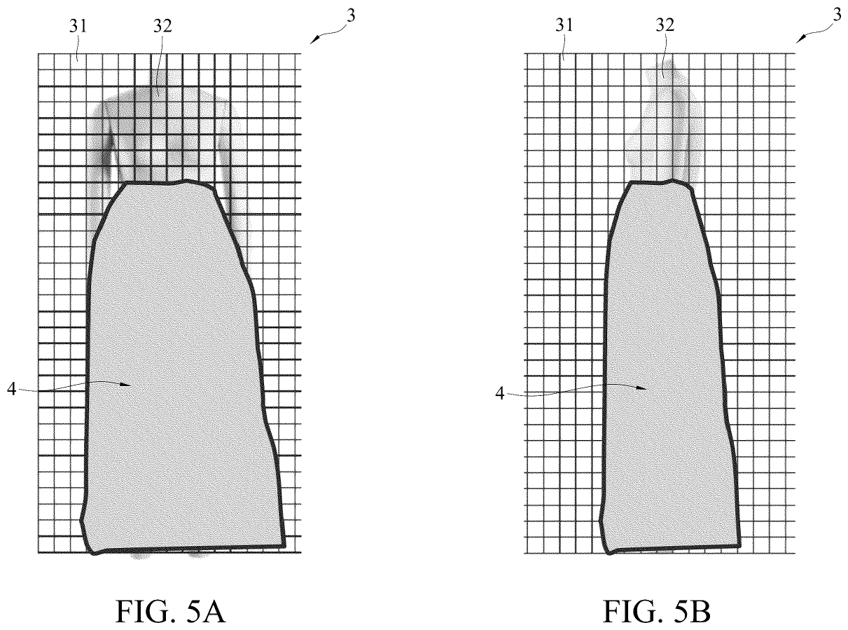

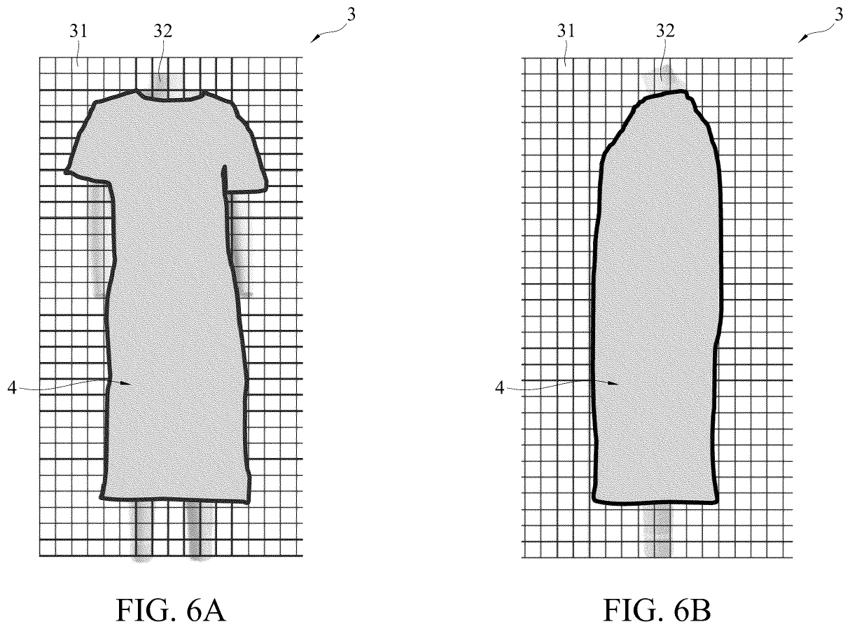

The contour type identification module 11 defines the position of the mannequin 32 to which the design drawing contour 4 is attached according to the mesh 31 to confirm the type of the design drawing contour 4. In detail, a coordinate system may be used and the specific position of each part of the mannequin 32 in the standardized design drawing 3 may be known from the mesh 31, and the specific position of the design drawing contour 4 in the standardized design drawing 3 may be identified to obtain the parts of the mannequin 32 corresponding to the design drawing contour 4 therefrom. For example, the design drawing contour 4 shown in FIG. 4A and FIG. 4B covers the upper arm and the lower arm of the mannequin 32, such that the design drawing contour 4 shown in FIG. 4A and FIG. 4B corresponds to a type of sleeve. The design drawing contour 4 shown in FIG. 5A and FIG. 5B covers the abdomen, the buttocks, the thighs and the calves of the mannequin 32, such that the design drawing contour 4 shown in FIG. 5A and FIG. 5B corresponds to a type of high-waisted and ankle-length skirt. The design drawing contour 4 shown in FIG. 6A and FIG. 6B covers the upper arms, the front chest, the back and the abdomen of the mannequin 32, such that the design drawing contour 4 shown in FIG. 6A and FIG. 6B corresponds to a type of T-shirt.

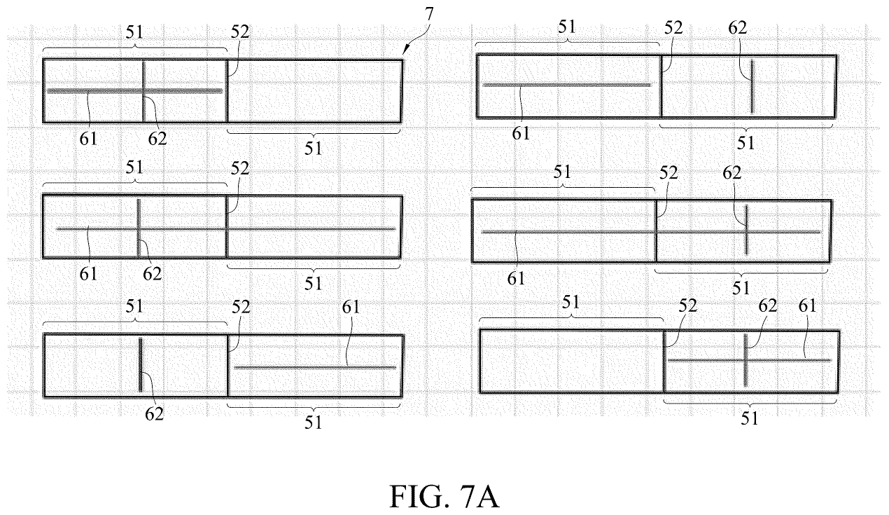

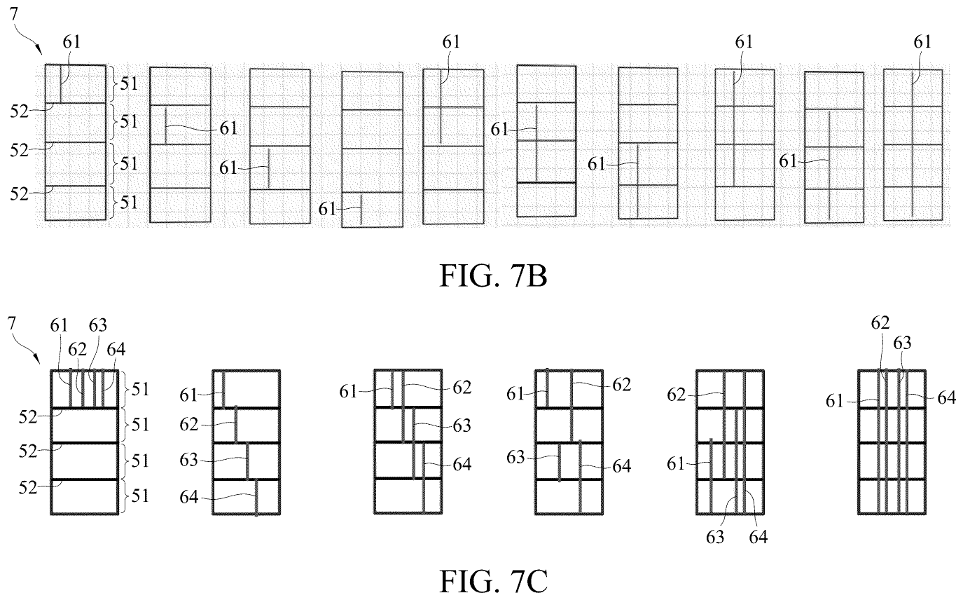

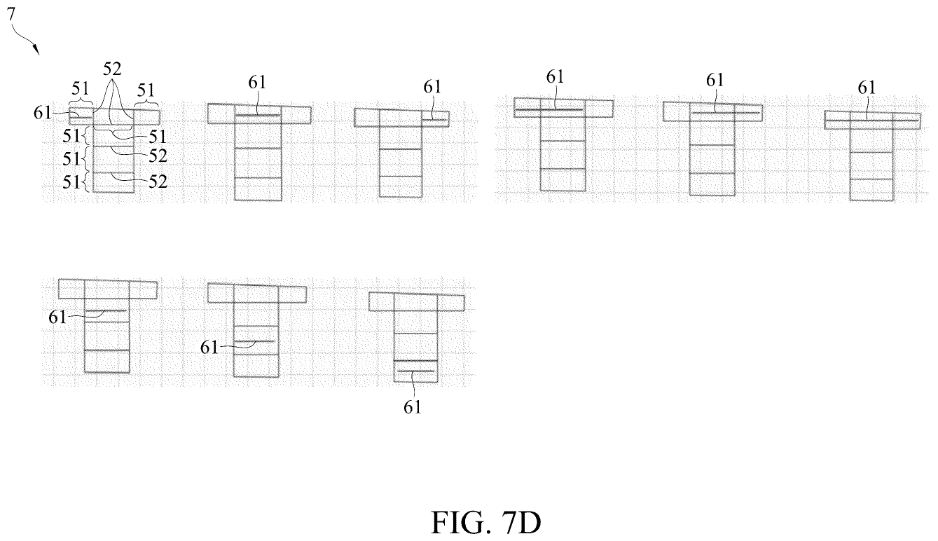

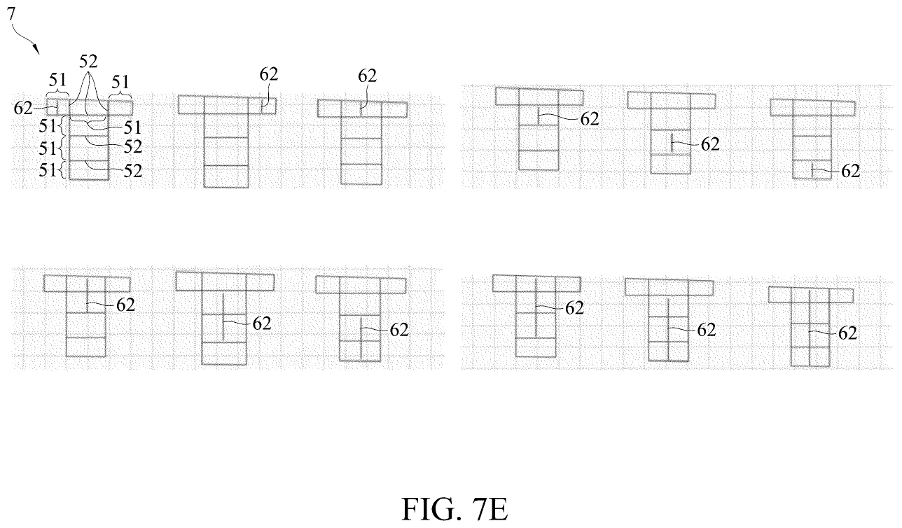

The definition module 12 defines the number of human body blocks and joints corresponding to the design drawing contour 4 according to the type of the design drawing contour 4. As shown in FIG. 7A, when the type of the design drawing contour 4 is a sleeve, it is defined that the sleeve corresponds to two human body blocks 51 and one joint 52. As shown in FIG. 7B and FIG. 7C, when the type of the design drawing contour 4 is a high-waisted and ankle-length skirt, it is defined that the high-waisted and ankle-length skirt corresponds to four human body blocks 51 and three joints 52. As shown in FIG. 7D and FIG. 7E, when the type of the design drawing contour 4 is a T-shirt, it is defined that the T-shirt corresponds to six human body blocks 51 and five joints 52.

The pattern generation module 13 calculates the combination number of garment technical drawings by means of using a corresponding algorithm according to the number of human body blocks 51, joints 52 and cutting lines 61, 62, 63, 64. The number of cutting lines 61, 62, 63, 64 can be determined by the user. The algorithm is as follows: if the number of human body blocks is 3, the number of joints is 2, and the number of cutting lines of parallel joints is k, the combination number of

$$garment technical drawings = \frac{( k + 2 ) \cdot ( k + 1 )}{2} ;$$

if the number of human body blocks is n, the number of joints is n−1, and the number of cutting lines of parallel joints is 2, the combination number of the

$$garment technical drawings = \frac{( n + 1 ) \cdot n}{2} ;$$

if the number of human body blocks is n, the number of joints is n−1, and the number of cutting lines of parallel joints is k, the combination number of the

$$garment technical drawings = \frac{( n + k - 1 ) !}{( n - 1 ) ! \cdot k !} ,$$

if the number of human body blocks is 3, the number of joints is 2, and the number of cutting lines of vertical joints is k, the combination number of the garment technical drawing is 6^{k}; if the number of human body blocks is n, the number of joints is n−1, and the number of cutting lines of vertical joints is 2, the combination number of the

$$garment technical drawings = {( \frac{n \cdot ( n + 1 )}{2} )}^{2} ;$$

if the number of human body blocks is n, the number of joints is n−1, and the number of cutting lines of vertical joints is k, the combination number of the

$$garment technical drawings = {( \frac{n \cdot ( n + 1 )}{2} )}^{k} ;$$

the if the number of human body blocks is n, the number of cutting lines of parallel joints is k1, and the number of cutting lines of vertical joints is k2, the combination number of the

$$garment technical drawings = \frac{( n + k 1 - 1 ) !}{( n - 1 ) ! k 1 !} \times {( \frac{n ( n + 1 )}{2} )}^{k 2} ;$$

and if the number of joints in a longitudinal direction is n1, the number of joints in a transverse direction is n2, the number of cutting lines in the longitudinal direction is k1, and the number of cutting lines in the transverse direction is k2, the combination number of the

$$garment technical drawings = {\sum }_{i = 0}^{k 1} \frac{( n 2 + i - 2 ) !}{( n 2 - 2 ) ! \times i !} \times {( \frac{n 1 ( n 1 + 1 )}{2} )}^{k 1 - i} \times {\sum }_{i = 0}^{k 2} \frac{( n 1 + i - 2 ) !}{( n 1 - 2 ) ! \times i !} \times {( \frac{n 2 ( n 2 + 1 )}{2} )}^{k 2 - i} ,$$

wherein n1≠1, n2≠1 and k1+k2≠0.

For example, when the type of the design drawing contour 4 is a sleeve, the number of cutting lines 61, 62 is 2, and the cutting lines 61, 62 are perpendicular to each other, the combination number of garment technical drawings for the sleeve is 6 as shown in FIG. 7A. For example, when the type of the design drawing contour 4 is a high-waisted and ankle-length skirt, and when the number of vertical cutting lines 61 is 1 as shown in FIG. 7B, the combination number of garment technical drawings for the high-waisted and ankle-length skirt is 10, and when the number of cutting lines 61, 62, 63, 64 of vertical joints is 4, the combination number of garment technical drawings for the high-waisted and ankle-length skirts is 10,000, and FIG. 7C shows 6 of them. For example, when the type of the design drawing contour 4 is a T-shirt and the number of transverse cutting lines 61 is 1, as shown in FIG. 7D, the combination number of garment technical drawings of the transverse cutting lines 61 is 9. If the number of longitudinal cutting lines 62 is 1, as shown in FIG. 7E, the combination number of garment technical drawings of the longitudinal cutting lines 62 is 12. As a result, it can be seen that the combination number of garment technical drawings having both transverse cutting lines 61 and longitudinal cutting lines 62 is 108.

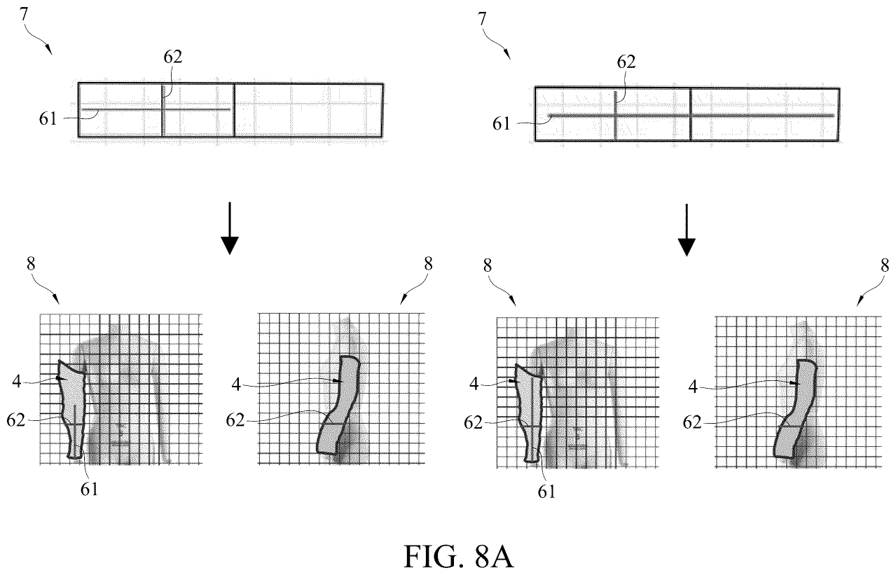

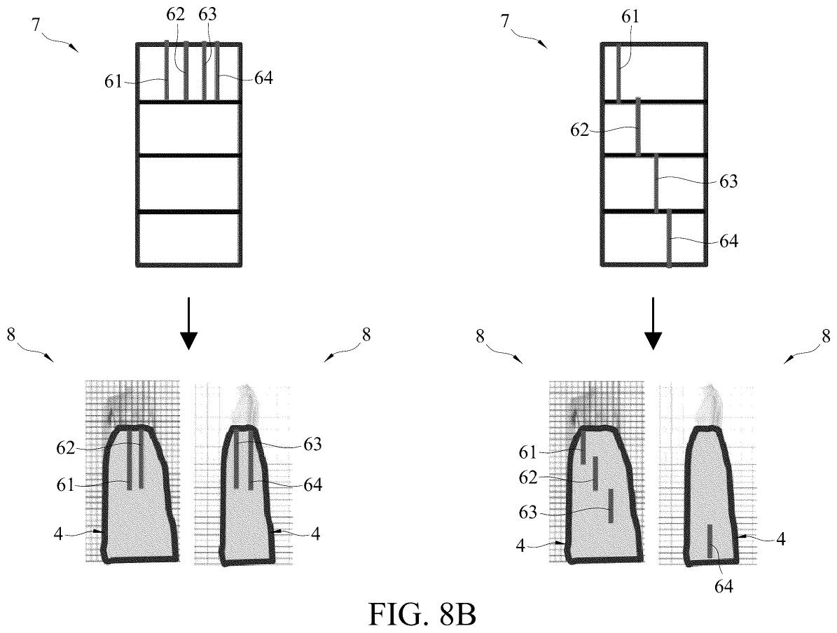

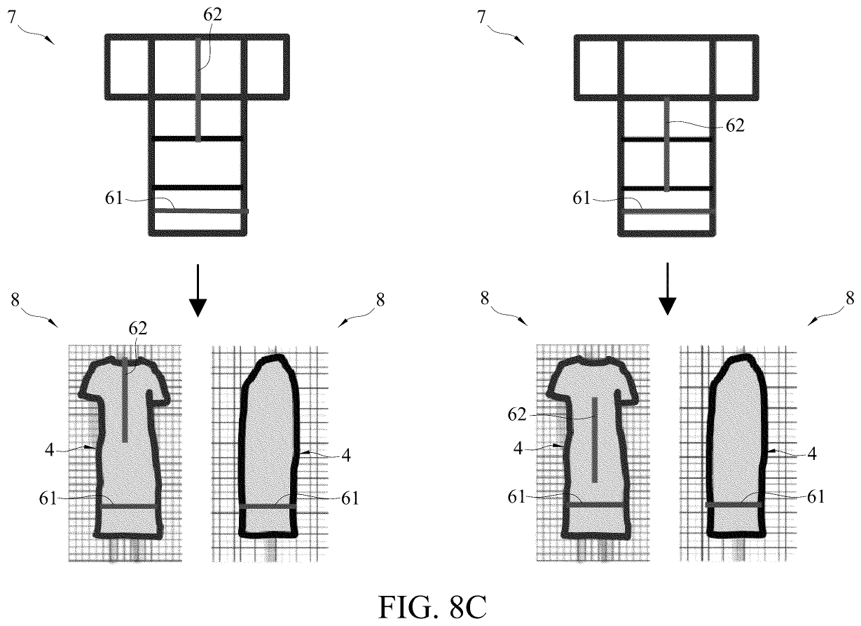

The garment technical and simulation drawing module 14 may generate a garment technical drawing 7 according to the combination number of garment technical drawings, and draw a garment simulation drawing 8 on the design drawing contour 4 according to the garment technical drawing 7, as shown in FIG. 8A, FIG. 8B and FIG. 8C (only two of which are shown as examples, respectively). In an embodiment, the garment technical drawings 7 are various permutations and combinations of different cutting lines in different human body blocks, and the garment simulation drawing 8 is to plot the positions of the cutting lines 61, 62, 63, 64 in the garment technical drawing 7 to the corresponding positions in the design drawing contour 4.

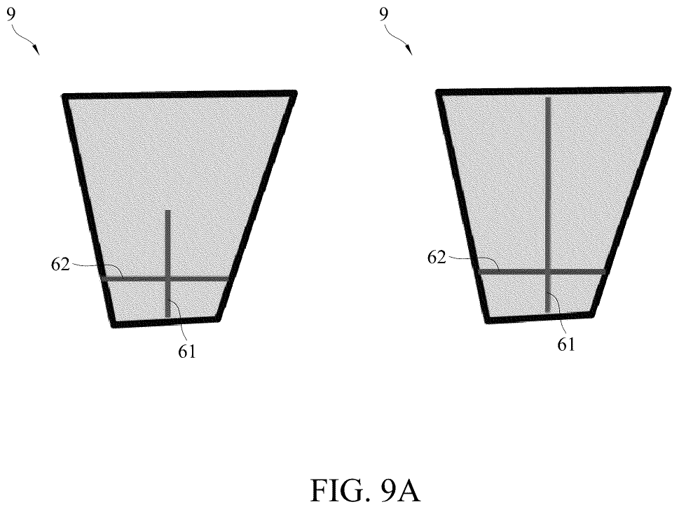

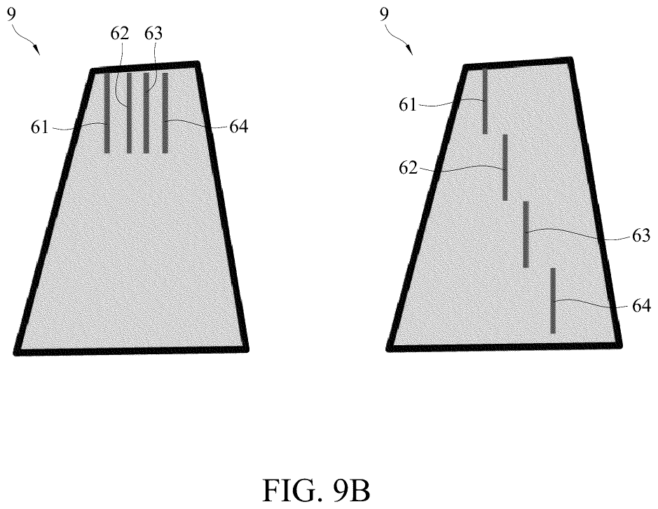

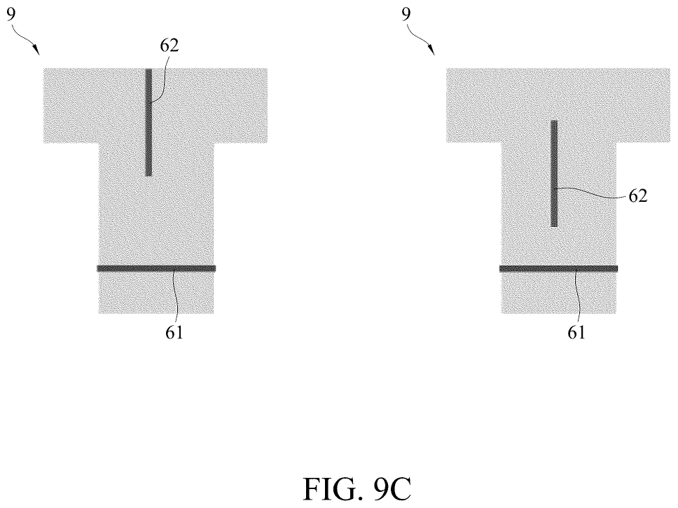

The garment pattern simulation drawing module 15 generates a one-piece garment pattern simulation drawing 9 according to the garment simulation drawing 8, as shown in FIG. 9A, FIG. 9B and FIG. 9C (only two of which are shown as examples, respectively). In an embodiment, the positions of the cutting lines 61, 62, 63, 64 in the garment simulation drawing 8 are drawn correspondingly into the one-piece sleeve, high-waisted and ankle-length skirt and T-shirt in order to generate the garment pattern simulation drawing 9.

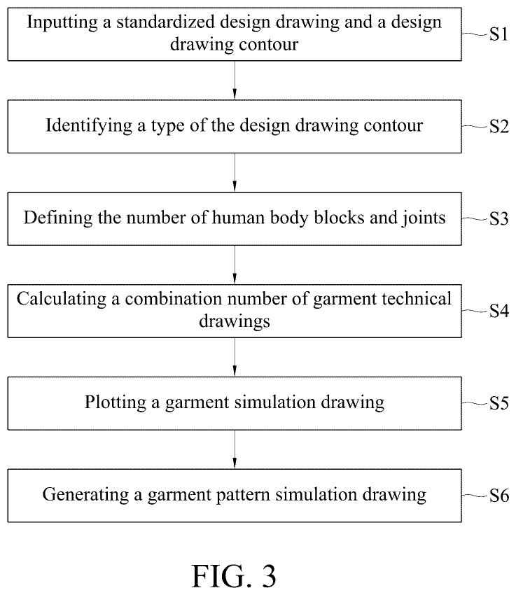

Referring to FIG. 3, the method for generating a garment pattern simulation drawing includes: inputting a standardized design drawing and a design drawing contour (step S1); identifying a type of the design drawing contour (step S2); defining the number of human body blocks and joints (step S3); calculating a combination number of garment technical drawings (step S4); plotting a garment simulation drawing (step S5); and generating a garment pattern simulation drawing (step S6). The method for generating a garment pattern simulation drawing of the present disclosure can be operated by the system 1 for generating the garment pattern simulation drawing, and the parts of the method and system that are technically the same are not repeated below.

In step S1, a standardized design drawing 3 and a design drawing contour 4 are inputted into an input device 10. The standardized design drawing 3 includes a mesh 31 and a mannequin 32 in the mesh 31, and the design drawing contour 4 is attached as a part of the mannequin 32. In step S2, a type of the design drawing contour 4 is identified by a contour type identification module 11 by means of defining a position of the mannequin 32 to which the design drawing contour 4 is attached according to the mesh 31. In step S3, the number of human body blocks 51 and joints 52 corresponding to the design drawing contour 4 is defined by a definition module 12 according to the type of the design drawing contour 4. In step S4, a combination number of garment technical drawings is calculated by a pattern generation module 13 by means of using a corresponding algorithm according to the number of the human body blocks 51, the joints 52 and the cutting lines 61, 62, 63, 64. In step S5, a garment technical drawing 7 is generated by a garment technical and simulation drawing module 14 according to the combination number of garment technical drawings, and a garment simulation drawing 8 is plotted on the design drawing contour 4 by the garment technical and simulation drawing module 14 according to the garment technical drawing 7. In step S6, a one-piece garment pattern simulation drawing 9 is generated by a garment pattern simulation drawing module 15 according to the garment simulation drawing 8.

In an embodiment, the algorithm is as follows: if the number of human body blocks is 3, the number of joints is 2, and the number of cutting lines of parallel joints is k, the combination number of

$$garment technical drawings = \frac{( k + 2 ) \cdot ( k + 1 )}{2} ;$$

if the number of human body blocks is n, the number of joints is n−1, and the number of cutting lines of parallel joints is 2, the combination number of the

$$garment technical drawings = \frac{( n + 1 ) \cdot n}{2} ;$$

if the number of human body blocks is n, the number of joints is n−1, and the number of cutting lines of parallel joints is k, the combination number of the

$$garment technical drawings = \frac{( n + k - 1 ) !}{( n - 1 ) ! \cdot k !} ;$$

if the number of human body blocks is 3, the number of joints is 2, and the number of cutting lines of vertical joints is k, the combination number of the garment technical drawing is 6^{k}; if the number of human body blocks is n, the number of joints is n−1, and the number of cutting lines of vertical joints is 2, the combination number of the

$$garment technical drawings = {( \frac{n \cdot ( n + 1 )}{2} )}^{2} ;$$

if the number of human body blocks is n, the number of joints is n−1, and the number of cutting lines of vertical joints is k, the combination number of the

$$garment technical drawings = {( \frac{n \cdot ( n + 1 )}{2} )}^{k} ;$$

if the number of human body blocks is n, the number of cutting lines of parallel joints is k1, and the number of cutting lines of vertical joints is k2, the combination number of the

$$garment technical drawings = \frac{( n + k 1 - 1 ) !}{( n - 1 ) ! k 1 !} \times {( \frac{n ( n + 1 )}{2} )}^{k 2} ;$$

and if the number of joints in a longitudinal direction is n1, the number of joints in a transverse direction is n2, the number of cutting lines in the longitudinal direction is k1, and the number of cutting lines in the transverse direction is k2, the combination number of the

$$garment technical drawings = {\sum }_{𝒾 = 0}^{k 1} \frac{( n 2 + 𝒾 - 2 ) !}{( n 2 - 2 ) ! \times 𝒾 !} \times {( \frac{n 1 ( n 1 + 1 )}{2} )}^{k 1 - 𝒾} \times {\sum }_{𝒾 = 0}^{k 2} \frac{( n 1 + 𝒾 - 2 ) !}{( n 1 - 2 ) ! \times 𝒾 !} \times {( \frac{n 2 ( n 2 + 1 )}{2} )}^{k 1 - 𝒾}$$

wherein n1≠1, n2≠1 and k1+k2≠0.

In summary, the system and method for generating a garment pattern simulation drawing of the present disclosure can identify the types of design drawing contours, calculate a combination number of garment technical drawings according to the number of human body blocks, joints and cutting lines, generate various permutations and combinations of garment technical drawings and corresponding garment simulation drawings, and ultimately generate various permutations and combinations of one-piece garment pattern simulation drawings. The system and method for generating a garment pattern simulation drawing of the present disclosure can provide inspiration for various permutations and combinations of the garment patterns, cutting lines, number of cutting lines and direction of cutting lines, thereby helping garment designers to enhance the efficiency of garment pattern research and development. In addition, the system and method for generating a garment pattern simulation drawing of the present disclosure can instantly calculate and automatically generate garment technical drawings, garment simulation drawings and garment pattern simulation drawings, thereby effectively improving the sampling time for realizing designs.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. However, any equivalent modifications and changes accomplished by utilizing the contents of the present disclosure shall still be covered by the scopes of the following claims. Therefore, the scope of protection of the rights of the present disclosure shall be set forth in the following claims.

What is claimed is:

1. A system for generating a garment pattern simulation drawing, comprising:
an input device configured for inputting a standardized design drawing and a design drawing contour, wherein the standardized design drawing includes a mesh and a mannequin in the mesh, and the design drawing contour is attached to a part of the mannequin;
a contour type identification module configured for identifying a type of the design drawing contour by defining a position of the mannequin to which the design drawing contour is attached according to the mesh;
a definition module configured for defining number of human body blocks and joints corresponding to the design drawing contour according to the type of the design drawing contour;
a pattern generation module configured for calculating a combination number of garment technical drawings by means of using a corresponding algorithm according to the number of the human body blocks, the joints and cutting lines;
a garment technical and simulation drawing module configured for generating a garment technical drawing according to the combination number of the garment technical drawings and plotting a garment simulation drawing on the design drawing contour according to the garment technical drawing; and
a garment pattern simulation drawing module configured for generating a one-piece garment pattern simulation drawing according to the garment simulation drawing.

2. The system of claim 1, wherein the type of the design drawing contour includes a sleeve, a high-waisted and ankle-length skirt and a T-shirt.

3. The system of claim 2, wherein the sleeve corresponds to two human body blocks and one joint, the high-waisted and ankle-length skirt corresponds to four human body blocks and three joints, and the T-shirt corresponds to six human body blocks and five joints.

4. The system of claim 1, wherein the algorithm is as follows: if the number of the human body blocks is 3, the number of the joints is 2, and the number of the cutting lines of parallel joints is k, the combination number of the
$$garment technical drawings = \frac{( k + 2 ) \cdot ( k + 1 )}{2} ;$$
if the number of the human body blocks is n, the number of the joints is n−1, and the number of the cutting lines of the parallel joints is 2, the combination number of the
$$garment technical drawings = \frac{( n + 1 ) \cdot n}{2} ;$$
and if the number of the human body blocks is n, the number of the joints is n−1, and the number of the cutting lines of the parallel joints is k, the combination number of the
$$garment technical drawings = \frac{( n + k - 1 ) !}{( n - 1 ) ! \cdot k !} .$$

5. The system of claim 1, wherein the algorithm is as follows: if the number of the human body blocks is 3, the number of the joints is 2, and the number of the cutting lines of vertical joints is k, the combination number of the garment technical drawing is 6^{k}; if the number of the human body blocks is n, the number of the joints is n−1, and the number of the cutting lines of the vertical joints is 2, the combination number of the
$$garment technical drawings = {( \frac{n \cdot ( n + 1 )}{2} )}^{2} ;$$
and if the number of the human body blocks is n, the number of the joints is n−1, and the number of the cutting lines of the vertical joints is k, the combination number of the
$$garment technical drawings = {( \frac{n \cdot ( n + 1 )}{2} )}^{k} .$$

6. The system of claim 1, wherein the algorithm is as follows: if the number of the human body blocks is n, the number of the cutting lines of parallel joints is k1, and the number of the cutting lines of vertical joints is k2, the combination number of the
$$garment technical drawings = \frac{( n + k 1 - 1 ) !}{( n - 1 ) ! k 1 !} \times {( \frac{n ( n + 1 )}{2} )}^{k 2} ;$$
and if the number of the joints in a longitudinal direction is n1, the number of the joints in a transverse direction is n2, the number of the cutting lines in the longitudinal direction is k1, and the number of the cutting lines in the transverse direction is k2, the combination number of the
$$garment technical drawings = {\sum }_{𝒾 = 0}^{k 1} \frac{( n 2 + 𝒾 - 2 ) !}{( n 2 - 2 ) ! \times 𝒾 !} \times {( \frac{n 1 ( n 1 + 1 )}{2} )}^{k 1 - 𝒾} \times {\sum }_{𝒾 = 0}^{k 2} \frac{( n 1 + 𝒾 - 2 ) !}{( n 1 - 2 ) ! \times 𝒾 !} \times {( \frac{n 2 ( n 2 + 1 )}{2} )}^{k 1 - 𝒾}$$
wherein n1≠1, n2≠1 and k1+k2≠0.

7. The system of claim 1, wherein the input device is a tablet, a laptop, a desktop, a cell phone, or a scanner.

8. A method for generating a garment pattern simulation drawing, comprising:
inputting a standardized design drawing and a design drawing contour into an input device, wherein the standardized design drawing includes a mesh and a mannequin in the mesh, and the design drawing contour is attached to a part of the mannequin;
identifying a type of the design drawing contour by a contour type identification module by means of defining a position of the mannequin to which the design drawing contour is attached according to the mesh;
defining number of human body blocks and joints corresponding to the design drawing contour by a definition module according to the type of the design drawing contour;
calculating a combination number of garment technical drawings by a pattern generation module by means of using a corresponding algorithm according to the number of the human body blocks, the joints and cutting lines;
generating a garment technical drawing according to the combination number of the garment technical drawings and plotting a garment simulation drawing on the design drawing contour according to the garment technical drawing by a garment technical and simulation drawing module; and
generating a one-piece garment pattern simulation drawing by a garment pattern simulation drawing module according to the garment simulation drawing.

9. The method of claim 8, wherein the type of the design drawing contour includes a sleeve, a high-waisted and ankle-length skirt and a T-shirt.

10. The method of claim 9, wherein the sleeve corresponds to two human body blocks and one joint, the high-waisted and ankle-length skirt corresponds to four human body blocks and three joints, and the T-shirt corresponds to six human body blocks and five joints.

11. The method of claim 8, wherein the algorithm is as follows: if the number of the human body blocks is 3, the number of the joints is 2, and the number of the cutting lines of parallel joints is k, the combination number of the
$$garment technical drawings = \frac{( k + 2 ) \cdot ( k + 1 )}{2} ;$$
if the number of the human body blocks is n, the number of the joints is n−1, and the number of the cutting lines of the parallel joints is 2, the combination number of the
$$garment technical drawings = \frac{( n + 1 ) \cdot n}{2} ;$$
and if the number of the human body blocks is n, the number of the joints is n−1, and the number of the cutting lines of the parallel joints is k, the combination number of the
$$garment technical drawings = \frac{( n + k - 1 ) !}{( n - 1 ) ! \cdot k !} .$$

12. The method of claim 8, wherein the algorithm is as follows: if the number of the human body blocks is 3, the number of the joints is 2, and the number of the cutting lines of vertical joints is k, the combination number of the garment technical drawing is 6^{k}; if the number of the human body blocks is n, the number of the joints is n−1, and the number of the cutting lines of the vertical joints is 2, the combination number of the
$$garment technical drawings = {( \frac{n \cdot ( n + 1 )}{2} )}^{2} ;$$
and if the number of the human body blocks is n, the number of the joints is n−1, and the number of the cutting lines of the vertical joints is k, the combination number of the
$$garment technical drawings = {( \frac{n \cdot ( n + 1 )}{2} )}^{k} .$$

13. The method of claim 8, wherein the algorithm is as follows: if the number of the human body blocks is n, the number of the cutting lines of parallel joints is k1, and the number of the cutting lines of vertical joints is k2, the combination number of the
$$garment technical drawings = \frac{( n + k 1 - 1 ) !}{( n - 1 ) ! k 1 !} \times {( \frac{n ( n + 1 )}{2} )}^{k 2} ;$$
and if the number of the joints in a longitudinal direction is n1, the number of the joints in a transverse direction is n2, the number of the cutting lines in the longitudinal direction is k1, and the number of the cutting lines in the transverse direction is k2, the combination number of the
$$garment technical drawings = {\sum }_{𝒾 = 0}^{k 1} \frac{( n 2 + 𝒾 - 2 ) !}{( n 2 - 2 ) ! \times 𝒾 !} \times {( \frac{n 1 ( n 1 + 1 )}{2} )}^{k 1 - 𝒾} \times {\sum }_{𝒾 = 0}^{k 2} \frac{( n 1 + 𝒾 - 2 ) !}{( n 1 - 2 ) ! \times 𝒾 !} \times {( \frac{n 2 ( n 2 + 1 )}{2} )}^{k 1 - 𝒾}$$
wherein n1≠1, n2≠1 and k1+k2≠0.

14. The method of claim 8, wherein the input device is a tablet, a laptop, a desktop, a cell phone, or a scanner.
